(19) United States
(12) Patent Application Publication
(10) Pub. No.: US 2009/0204856 A1
(43) Pub. Date: Aug. 13, 2009

(54) Self-service terminal

(76) Inventors: Colin A. Sinclair, Carnoustie (GB); Michael Taylor, Dundee (GB)

Correspondence Address: MICHAEL CHAN;NCR CORPORATION, 1700 SOUTH PATTERSON BLVD, DAYTON, OH, 45479-0001, US

(21) Appl. No.: 12/069,337

(22) Filed: Feb. 8, 2008

(51) Int. Cl. G06F 11/00

(52) U.S. Cl. 714/48; 714/E11.002

(57) ABSTRACT

A self-service terminal comprises a watchdog timer coupled to a clock; and a reset driver for resetting the watchdog timer. The reset driver is operable to monitor a count reached by the watchdog timer, and to instigate a diagnostic action, such as writing information to a system event log, in the event that the count reaches a first predefined number.

### FIELD OF INVENTION

The present invention relates to a self-service terminal. In particular, but not exclusively, the present invention relates to an automated teller machine (ATM).

### BACKGROUND OF INVENTION

Many ATMs are typically located in an unattended environment. As a result, the ATM must be able to ensure that it remains in operation without any intervention from a user of the ATM. Any hardware or software problems may cause the ATM to enter a “hung” state. To restore such an ATM to normal operation, an ATM technician typically has to visit the ATM to repair or replace any defective parts (software or hardware) and to reset the ATM. These ATM technician visits are expensive for the ATM owner and introduce an extended time period during which the ATM cannot be used by ATM customers desiring to execute transactions at that ATM. They are therefore expensive and undesirable.

### SUMMARY OF INVENTION

Accordingly, the invention generally provides methods, systems, apparatus, and software for monitoring a timer circuit to detect a potential problem.

In addition to the Summary of Invention provided above and the subject matter disclosed below in the Detailed Description, the following paragraphs of this section are intended to provide further basis for alternative claim language for possible use during prosecution of this application, if required. If this application is granted, some aspects of the invention may relate to claims added during prosecution of this application, other aspects may relate to claims deleted during prosecution, other aspects may relate to subject matter never claimed. Furthermore, the various aspects detailed hereinafter are independent of each other, except where stated otherwise. Any claim corresponding to one aspect should not be construed as incorporating any element or feature of the other aspects unless explicitly stated in that claim.

According to a first aspect there is provided a self-service terminal comprising a watchdog timer coupled to a clock; and a reset driver operable (i) to monitor a count reached by the watchdog timer, (ii) to reset the watchdog timer, and (iii) in the event that the count reaches a first predefined number to instigate a first diagnostic action.

The first diagnostic action may include: writing an event to a system event log.

Where an event is written to the system event log, the event log may list the reset driver as the source of the event. The event log may be used as an error log file so that the information can be analysed to ascertain if there was a trend of count values being below the expected value.

The reset driver may be operable to (iv) instigate a second diagnostic action in the event that the count reaches a second predefined number.

The second diagnostic action may include: invoking a kernel exception.

The kernel exception may give rise to a memory dump being written to a file, the self-service terminal being re-booted, a “blue screen” being displayed, or the like. The specific action instigated may depend on how an operating system on the self-service terminal is configured to respond to kernel exceptions.

The memory dump may be a mini dump, a kernel dump, a complete dump, or the like.

The count is preferably a decrementing count (that is, counting downwards), but it may optionally be an incrementing count (that is, counting upwards) if the hardware supports such a count.

Where a decrementing count is used, the first predefined number may correspond to a number higher than zero, and the second predefined number may correspond to a number between the first predefined number and zero. This ensures that if the self-service terminal begins to operate more slowly than normal, then diagnostic action can be taken to record this. If the self-service terminal begins to operate much more slowly than normal then further diagnostic action (leading potentially to a re-boot of the self-service terminal) can be implemented prior to the self-service terminal hanging. This further diagnostic action can include saving a snap-shot of the memory (that is, a memory dump) so that the software loaded into the memory when the processor operates much more slowly than expected can be analysed once the terminal has been re-booted. This would help in detecting any software errors that may have caused the problem.

Where an incrementing count is used, the first predefined number may correspond to a number lower than a number representing the maximum count. This ensures that if the self-service terminal begins to operate more slowly than normal, then corrective action can be taken prior to the self-service terminal hanging.

The reset driver may be an upper filter driver layered on top of a driver provided by an operating system provider, such as the isapnp.sys driver from Microsoft Corporation (trade mark).

The watchdog timer may be provided as part of an input/output controller hub (ICH). Commercial ICHs are available that provide watchdog timers. Suitable commercial ICHs include those provided by Intel Corporation (trade mark) that have a low pin count (LPC) interface bridge including a total cost of ownership (TCO) logic unit.

The self-service terminal may be an automated teller machine (ATM), an information kiosk, a financial services centre, a bill payment kiosk, a lottery kiosk, a postal services machine, a check-in and/or check-out terminal such as those used in the hotel, car rental, healthcare, and airline industries, a retail self-checkout terminal, a vending machine, or the like.

By virtue of this aspect, a watchdog timer can be clocked separately from a processor, so that the watchdog timer serves as an independent reference for the speed at which the processor is operating. By monitoring the count reached, the reset driver can be used to ascertain when the processor is operating too slowly (and therefore liable to hang) and take appropriate action. This aspect allows a watchdog to be used at the kernel level to help diagnose any errors in a self-service terminal that would otherwise cause the self-service terminal to hang. This enables detection of problems at the microprocessor level, or in very low-level software such as a loop in an interrupt service routine.

According to a second aspect there is provided a method of monitoring operation of a self-service terminal, the method comprising: using a timer to control counting to a reset number; using a processor to control execution of a reset driver for resetting the timer; monitoring a count reached by the timer prior to resetting the timer; and, instigating a first diagnostic action in the event that the count reaches a first predefined number.

The method may further comprise instigating a second diagnostic action, such as invoking a kernel exception, in the event that the count reaches a second predefined number, where the second predefined number is reached prior to the reset number.

The reset number may be configurable, and retrieved from a registry by a reset driver.

The first predefined number may be the same as the second predefined number, but in preferred embodiments, the first and second predefined numbers are different, and the first predefined number is reached prior to the second predefined number.

The timer may increment until a maximum number is reached. Alternatively, the timer may start at a predefined number and decrement until zero is reached.

Where a decrementing count is used, the reset number is zero, the second predefined number may correspond to a number slightly higher than zero, and the first predefined number may correspond to a number higher than the second predefined number. This ensures that if the self-service terminal begins to operate more slowly than normal, then diagnostic action can be taken prior to the self-service terminal hanging.

Where an incrementing count is used, the second predefined number may correspond to a number lower than the reset number, and the first predefined number may correspond to a number lower than the second predefined number. This ensures that if the self-service terminal begins to operate more slowly than normal, then diagnostic action can be taken prior to the self-service terminal hanging.

According to a third aspect there is provided a method of monitoring operation of a self-service terminal, the method comprising: counting to a reset number using a hardware timer; using a processor to provide a timed signal, where the timed signal is associated with the speed of operation of the processor; monitoring a count reached by the hardware timer when the timed signal is provided; resetting the hardware timer in response to the timed signal being provided; and, instigating a first diagnostic action in the event that the count reaches a first predefined number.

The timed signal may be provided by a deferred procedure call (DPC).

The count may be a decrementing count.

Resetting the hardware timer may comprise reloading the hardware timer with a configuration value obtained from an operating system registry.

The method may also include instigating a second diagnostic action in the event that the count reaches a second predefined number.

These and other aspects will be apparent from the following specific description, given by way of example, with reference to the accompanying drawings.

### BRIEF DESCRIPTION OF THE DRAWINGS

FIG. 1 is a block diagram illustrating the architecture of a self-service terminal according to one embodiment of the present invention;

FIG. 2 is a schematic diagram illustrating software components executing in a part (the controller) of the SST of FIG. 1; and

FIG. 3 is a flowchart illustrating the steps implemented by one of the software components (the reset driver) of FIG. 2.

### DETAILED DESCRIPTION

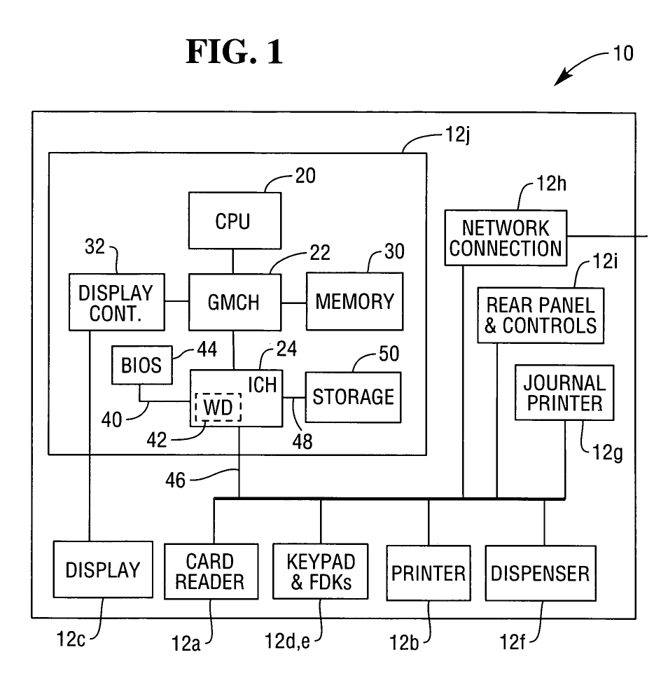

Reference is first made to FIG. 1, which is a block diagram illustrating the architecture of a self-service terminal 10, in the form of an ATM, according to one embodiment of the present invention.

The ATM 10 comprises a plurality of internal devices 12 mounted within the ATM 10, including: a card reader device 12a; a receipt printer device 12b; a display 12c and associated function display keys (FDKs) 12d disposed as two columns, each on opposing narrow sides of the display 12c; an encrypting keypad device 12e; a dispenser device 12f; a journal printer device 12g for creating a record of every transaction executed by the ATM 10, a network device 12h for accessing a remote host (not shown); a rear operator panel (including control switches in the form of small FDKs) 12i, and a controller device 12j (in the form of a PC core) for controlling the operation of the ATM 10, including the operation of the other devices 12.

The controller 12j is based on the 815 series chipsets available from Intel Corporation (trade mark), and comprises one or more microprocessors (CPU) 20 coupled to a graphics and memory controller hub (GMCH) 22, which in turn is coupled to an input/output controller hub (ICH) 24. All of the components shown in FIG. 1 within controller 12j are mounted on a motherboard.

The GMCH 22 is coupled to main memory 30, and to a display controller 32, in the form of a graphics card, which is coupled to the display 12c.

The ICH 24 provides ports, bridges, and interfaces for various input/output devices, as will now be described.

The ICH 24 includes a low pin count (LPC) interface bridge 40 comprising various circuits, including a total cost of ownership (TCO) logic unit that has a watchdog timer 42. Full details of these circuits are available from Intel Corporation, see for example the application note entitled “Using the Intel ICH Family Watchdog Timer (WDT)”, Application Note: AP-725, September 2002, Revision 001.

A non-volatile memory 44 storing a BIOS is also connected to the ICH 24 via the LPC interface bridge 40.

The ICH 24 includes USB ports (illustrated by bus 46) to which many of the devices 12 are coupled.

The ICH 24 also includes an IDE (PATA) disk interface 50 to which a disk drive 50 is coupled.

Initialisation of the ATM

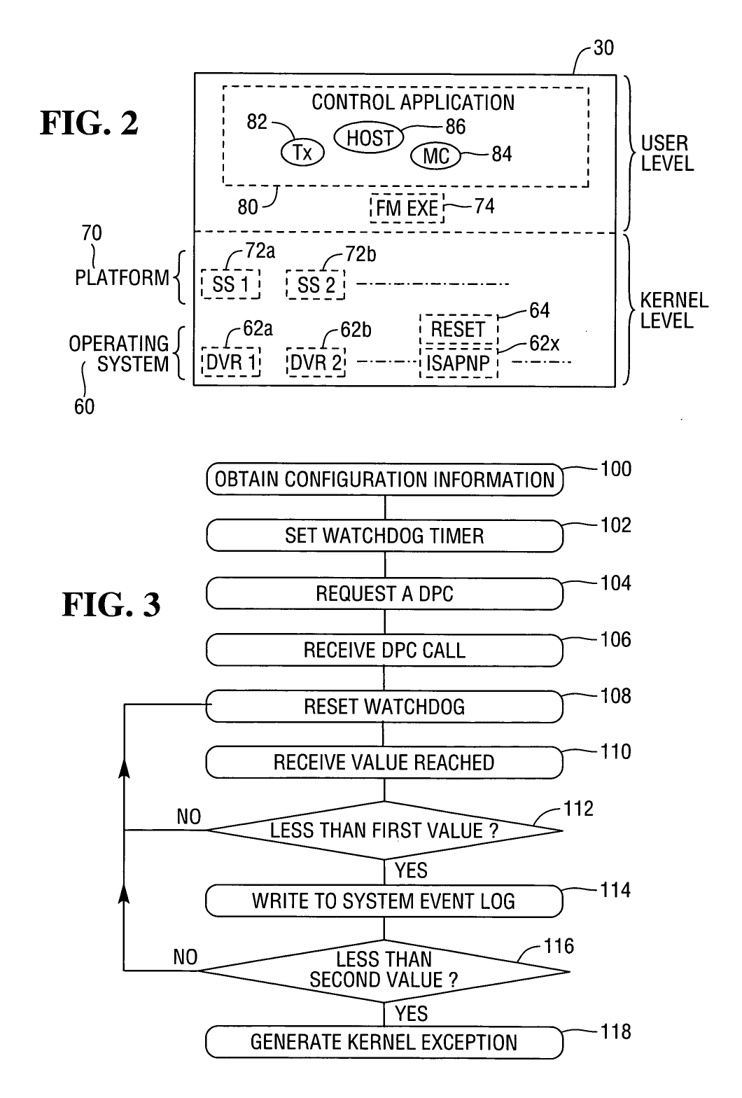

When the ATM 10 is booted up, the microprocessor 20 accesses the BIOS and ascertains what PCI devices are present. The microprocessor 20 then accesses the disk drive 50 and loads the main memory 30 with software components, as will be described with reference to FIG. 2, which is a schematic diagram illustrating how software components interact in main memory 30.

Operating System

The microprocessor 20 loads an operating system kernel 60 into the main memory 30. In this embodiment, the operating system is a Windows XP (trade mark) operating system, available from Microsoft Corporation (trade mark).

The microprocessor 20 loads a plurality of device drivers 62a,b, . . . for interfacing with standard computing devices such as the hard drive 50, the display 12c, a serial port, and the like. These device drivers 62 are loaded based on the devices that are present (identified during the boot-up procedure).

These device drivers 62 also include the conventional Windows XP driver (“isapnp.sys”) 62x which identifies the physical devices present and publishes a Physical Device Object (PDO) for each device (including the watchdog timer PCI device 42). The PDO includes a vendor identification and a product identification. The isapnp.sys driver 62x

The microprocessor 20 also loads a reset driver 64 (which is a Plug and Play (PnP) upper filter driver) that utilises the functions of the watchdog timer 42. The reset driver 64 is loaded at the same time as the conventional Windows XP drivers, and sits over the top of the isapnp.sys driver 62x. The reset driver 64 is fully compatible with PnP standards and installs silently, layering itself over the top of the existing Microsoft Windows (trade mark) isapnp.sys driver 62x.

Run-Time Platform

The microprocessor 20 also loads a run-time platform 70 into the main memory 30. In this embodiment, the runtime platform 70 is a set of APTRA (trade mark) XFS components, available from NCR Corporation, 1700 S. Patterson Blvd., Dayton, Ohio 45479, U.S.A. The run-time platform 70 provides a range of programming facilities specific to self-service terminal devices and services.

The run-time platform 70 includes a plurality of self-service device drivers 72a,b, . . . that interface with self-service specific devices (such as the card reader device 12a, the receipt printer device 12b, and the like). The run-time platform 70 also includes a feature manager executable file 74 containing feature managers (not shown) and other components for adding self-service functionality (for example, supporting XFS-compliant commands) to devices 12.

One function of the run-time platform 70 is to enhance the operating system 60 so that the operating system and run-time platform 70 together provide high level access to all of the devices 12, including both standard computing devices (via the operating system 60), and non-standard computing devices (via the run-time platform 70). Thus, the combination of the run-time platform 70 and the operating system 60 can be viewed as providing a complete ATM operating system.

Control Application

The microprocessor 20 also loads a control application (CA) 80 into the main memory 30. For clarity, and to aid understanding, the CA 80 is represented in FIG. 2 as comprising a number of logical components: a transaction processing component 82; a management component 84; and a host communication component 86 for relaying transaction and device management information to a remote host.

The transaction processing component 82 provides transaction processing functions for customers and for maintenance personnel. This allows customers to execute transactions at the ATM 10, and maintenance personnel to diagnose, maintain, and repair devices 12 in the ATM 10.

The management component 84 provides device management functions in response to requests received from the host 12, and/or from maintenance personnel at the ATM 10.

Operation of Watchdog Timer 42

The watchdog timer 42 includes timer and recovery hardware that works independently of the microprocessor 20. The watchdog timer 42 is programmed with a timer value (which the reset driver 64 reads from the operating system registry, as explained in more detail below) and counts down to zero at a preset rate (based on a clock on the motherboard).

If the watchdog timer 42 reaches zero, then it will set a flag and optionally generate an interrupt; if the watchdog timer 42 reaches zero a second time without the flag being cleared by software action (that is, by the reset driver 64) it will then reset the motherboard, causing the entire ATM 10 to re-boot.

Operation of Reset Driver 64

The owner and/or operator of the ATM 10 edits the operating system registry to include configuration information associated with the reset driver 64. This configuration information includes the starting value from which the watchdog timer 42 will count down, as well as a value indicating the mode that the reset driver 64 will operate in (for example, normal mode or testing mode). When operated in testing mode (also referred to as debug mode), the reset driver 64 will reset the watchdog timer 42 for a configurable time period (such as ten minutes) and then stop resetting the watchdog timer 42. This enables an ATM technician to observe what happens when the watchdog timer 42 times out (after it has been running for the configurable time period) and the ATM 10 is reset.

On the 815 series chipsets, the watchdog timer 42 counts down once, sets a flat, counts down again, and only resets the ATM 10 if a zero count is reached a second time (that is, when the flag is already set). Thus, the starting value is halved and applied to the counter circuit in the watchdog timer 42.

Configuration information associated with the reset driver 64 may also include (i) a value that indicates that the reset driver 64 should log the lowest value reached by the watchdog timer 42 prior to being reset; and/or (ii) a value that indicates that the reset driver 64 should trigger a kernel exception.

The operation of the reset driver 64 will now be described with reference to FIG. 3, which is a flowchart illustrating the steps taken by the reset driver 64 to set the watchdog timer 42 during normal operation.

On start-up, the reset driver 64 queries the registry for the configuration information (step 100) and programs the watchdog timer 42 on the LPC interface bridge 40 based on this information (step 102). In this example, the countdown is configured to be ten seconds. In this embodiment, programming the watchdog timer 42 involves the reset driver 64 dividing the time period (ten seconds) into two equal amounts (five seconds) because the watchdog timer 42 has a single counter that counts down twice. The reset driver 64 then converts this divided time period (five seconds) into an equivalent count value by dividing it by zero point six (“0.6”), which yields eight point three recurring (8.333 . . . ), and rounding up (to nine). It is this value of nine that is loaded into the watchdog timer 42.

The reset driver 64 then calls the kernel 60 to request the kernel 60 to schedule timer deferred procedure calls (DPCs) (step 104) and provides the kernel with the value of time delay between DPCs. In this example, the reset driver 64 requests timer DPCs every second. The kernel 60 adds the request to its list of DPCs, and also adds information about the requested time delay between DPCs for the reset driver 64. When the time delay for the reset driver DPC elapses, the microprocessor 20 sends a call to the reset driver 64 (step 106).

In this embodiment, the first and second predefined numbers are calculated by the reset driver 64 based on the time period read from the configuration information in the registry.

The first predefined number is equivalent to one half of the divided time period (that is, one half of five seconds, which is two point five “2.5” seconds), and the second predefined number is equivalent to one quarter of the divided time period (that is, one quarter of five seconds, which is one point two five “1.25” seconds). These time periods are converted to count values and rounded down to the nearest whole value (in this embodiment a multiple of zero point six). Thus, the first predefined number approximately equivalent to 2.5 seconds is three point six (3.6) on the watchdog timer counter and the second predefined number approximately equivalent to 1.25 seconds is one point eight (1.8) on the watchdog timer counter.

If a DPC call is not initiated in time, both the first and second predefined numbers are reached by the watchdog timer 42 counting down to zero the first time. If the DPC call is initiated in time, then the watchdog timer 42 should never reach zero, so it should never set its flag.

On receipt of this call, the reset driver 64 immediately queries the watchdog timer 42 to retrieve the current value of the count, and then re-programs the watchdog timer 42 (step 108), causing the watchdog timer 42 to reload its initial count (the value of nine, which is equivalent to approximately five seconds). The reset driver 64 receives the value of count reached by the watchdog timer 42 immediately prior to the reset (step 110).

If the value of the count reached is lower than a first predefined number (which is 3.6, as described above) (step 112), then the reset driver 64 writes an entry to a system event log (step 114). Writing an entry to the system event log creates a permanent record indicating that the count on the watchdog timer 42 was lower than 3.6 when the reset driver 64 reloaded the count. The actual value reached by the watchdog timer 42 (for example, 3.0) is recorded in the system event log. The source of the event log entry is recorded as the TCO filter (which is the reset driver 64).

If the value of the count reached is also lower than a second predefined number ((which is 1.8, as described above) (step 116), then the reset driver 64 also invokes a kernel exception (step 118). In this embodiment, the second predefined number of 1.8 is equivalent to approximately one second left on the first count down, that is, without the flag being set.

The action taken when a kernel exception is triggered will depend on how the operating system is configured to respond to a kernel exception. Typically, the operating system will write a dump of the memory contents to a file and then re-boot the ATM 10. When the ATM 10 is re-booted, the dump of the memory and the system event log can be analysed to help diagnose any possible software problem that may have caused the processor 20 to slow down.

If the reset driver 64 does not reset the watchdog timer 42 prior to the watchdog timer 42 counting down from its initial value on two successive occasions, then the watchdog timer 42 will reset the motherboard and reboot the ATM 10.

It will now be apparent that the reset driver 64 is programmed to ensure that the watchdog timer 42 is always reset prior to reaching a zero count. The reset driver 64 uses a timer DPC to keep reprogramming the timer. A timer DPC runs at very high priority in the Windows kernel scheduling system (at a higher priority than any threads). Since the reset driver's timer DPC is essentially running at very high priority, if it stops then the microprocessor 20 is actually stopped; and if it runs more slowly than it should, then some fault (hardware or software) is affecting the normal software processing sequence or operation of the microprocessor 20. This means that the timer DPC provides a very good indication of the current processing speed of the microprocessor 20.

The maximum time value for the watchdog timer 42 is limited by the watchdog timer hardware. This maximum value may be too long for certain environments. For example, if the ATM 10 hangs during a transaction, then it is preferable to detect this prior to the customer leaving the ATM (without his/her card). In some embodiments, the watchdog timer 42 may be set to a maximum value of ten seconds, so that if the ATM 10 hangs, then the customer's ATM card can be returned to the customer while the customer is still present at the ATM 10.

In this embodiment, the ATM 10 is programmed to eject any inserted card (magnetic card, integrated circuit card, or the like) as soon as the ATM 10 re-boots. The reason for this is that the customer will probably still be present at the ATM 10 when the ATM 10 re-boots, so the customer will be able to retrieve his/her card once the ATM 10 has re-booted.

The reset driver 64 can be also configured for test mode (through a registry setting), so that it will stop re-programming the watchdog timer 42 after an initial period has elapsed. This allows an ATM technician to test if the ATM 10 will reset when a microprocessor hangs.

Various modifications may be made to the above described embodiment within the scope of the invention, for example, a different chipset may be used than that described above. Although the TCO hardware interface varies across various versions of the input/output controller hub devices, the variation in Intel ICH series chipsets is small enough and the different versions can be identified, so the same reset driver 64 can be deployed throughout an ATM network which typically contains ATMs with different motherboards.

In other embodiments, a different series of chipsets, for example, the 965 series, or a different chipset manufacturer, may be used than the one described above.

In other embodiments, the ICH may provide a serial ATA (SATA) bus and/or other buses and interfaces than those described above.

In other embodiments, a self-service terminal other than an ATM may be used, for example, a self-checkout terminal.

In other embodiments, the value of the count may change in increments different to zero point six. In other embodiments, the first and second predefined numbers may be programmable, so that they can be selected as part of the configuration information rather than being calculated by the reset driver.

The steps of the methods described herein may be carried out in any suitable order, or simultaneously where appropriate. The methods described herein may be performed by software in machine readable form on a tangible storage medium or as a propagating signal.

The terms “comprising”, “including”, “incorporating”, and “having” are used herein to recite an open-ended list of one or more elements or steps, not a closed list. When such terms are used, those elements or steps recited in the list are not exclusive of other elements or steps that may be added to the list.

What is claimed is:

1. A self-service terminal comprising:
a watchdog timer coupled to a clock; and
a reset driver operable
(i) to monitor a count reached by the watchdog timer,
(ii) to reset the watchdog timer, and
(iii) in the event that the count reaches a first predefined number to instigate a first diagnostic action.

2. A self-service terminal according to claim 1, wherein the count is a decrementing count and the first predefined number corresponds to a number higher than zero.

3. A self-service terminal according to claim 1, wherein the first diagnostic action includes writing an event to a system log file so that the system log file can be analysed to ascertain if there is a trend of count values being below the first predefined number.

4. A self-service terminal according to claim 1, wherein the reset driver is further operable (iv) to instigate a second diagnostic action in the event that the count reaches a second predefined number.

5. A self-service terminal according to claim 4, wherein the second diagnostic action includes invoking a kernel exception and thereby causing an operating system to copy contents of memory to a file.

6. A self-service terminal according to claim 1, wherein the reset driver is an upper filter driver layered on a driver provided by an operating system.

7. A self-service terminal according to claim 1, wherein the terminal includes a cash dispenser.

8. A method of monitoring operation of a self-service terminal, the method comprising:
using a timer to control counting to a reset number;
using a processor to control execution of a reset driver for resetting the timer;
monitoring a count reached by the timer prior to resetting the timer; and,
instigating a first diagnostic action in the event that the count reaches a first predefined number.

9. A method according to claim 8, wherein the method further comprises: instigating a second diagnostic action including invoking a kernel exception in the event that the count reaches a second predefined number, where the second predefined number is reached prior to the reset number.

10. A method of monitoring operation of a self-service terminal, the method comprising:
counting to a reset number using a hardware timer;
using a processor to provide a timed signal, where the timed signal is associated with the speed of operation of the processor;
monitoring a count reached by the hardware timer when the timed signal is provided;
resetting the hardware timer in response to the timed signal being provided; and,
instigating a first diagnostic action in the event that the count reaches a first predefined number.

11. A method according to claim 10, wherein the timed signal is provided by a deferred procedure call (DPC).
